(19) United States
(12) Patent Application Publication
(10) Pub. No.: US 2010/0073506 A1
(43) Pub. Date: Mar. 25, 2010

(54) IMAGE PROCESSOR AND CAMERA

(75) Inventors: Hiroyasu UEHARA, Saitama (JP); Tomohiko KANZAKI, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/561,550

(22) Filed: Sep. 17, 2009

(30) Foreign Application Priority Data
Sep. 19, 2008 (JP) 2008-240844

(51) Int. Cl. G06K 9/32; G06K 9/46; H04N 5/228

(52) U.S. Cl. 348/222.1; 382/190; 382/294; 348/E05.031

(57) ABSTRACT

An image processor is provided that includes an image priority order determining processor, an image arranging processor, and a composite image creating processor. The image priority order determining processor determines priority order among a plurality of images based on predetermined priority information. The image arranging processor arranges the plurality of images with a layout that distinguishes images having higher priority in the priority order. The composite image creating processor synthesizes the plurality of images arranged by the image arranging processor into a composite image and stores the composite image in memory.

### BACKGROUND OF THE INVENTION

1. Field of the Invention

The present invention relates to an image processor that synthesizes images to create one new image, and further to a camera provided with the image processor, and to an image processing method applied therein.

2. Description of the Related Art

Image management software for a computer or a printer that is provided with a function to create a single image from a plurality of images is known. Such image management software creates a composite image by regularly arranging a plurality of thumbnail images as a contact sheet or an index print used for a photography film. The composition is carried out for all images in one folder or a plurality of images selected by a user. The images are arranged regularly according to the order of file names, times, or order chosen by a user.

### SUMMARY OF THE INVENTION

However, the conventional systems are unable to define the order of images that are automatically selected. Furthermore, they do not have the ability to provide a particular arrangement of images according to the priority of images.

An object of the present invention is to automatically determine the order of priority for a plurality of images based on a predetermined priority, and to create a composite image where images of higher priority are arranged to stand out.

According to the present invention, an image processor is provided that includes an image priority order determining processor, an image arranging processor, and a composite image creating processor.

The image priority order determining processor determines the order of priority among a plurality of images based on predetermined priority information. The image arranging processor arranges the plurality of images in a layout that distinguishes images of higher priority. The composite image creating processor synthesizes the plurality of images arranged by the image arranging processor into a composite image and stores the composite image in memory.

### BRIEF DESCRIPTION OF THE DRAWINGS

The objects and advantages of the present invention will be better understood from the following description, with reference to the accompanying drawings in which:

FIG. 1 is a block diagram showing the general structures of a camera that executes composite image creating processing of a first embodiment to which the present invention is applied;

FIG. 2 is a flowchart of a composite image creating process of a first embodiment;

FIG. 3 illustrates a layout of the composite image in the first embodiment;

FIG. 4 illustrates an example of image trimming around a face;

FIG. 5 is a flowchart of the composite image creating process of the second embodiment;

FIG. 6 illustrates a layout of the composite image in the second embodiment;

FIG. 7 is a flowchart of the composite image creating process of the third embodiment;

FIG. 8 is a flowchart of the composite image creating process of the fourth embodiment;

FIG. 9 is a flowchart of the composite image creating process of the fifth embodiment; and

FIG. 10 is a flowchart of the composite image creating process of the sixth embodiment.

### DESCRIPTION OF THE PREFERRED EMBODIMENTS

The present invention is described below with reference to the embodiments shown in the drawings.

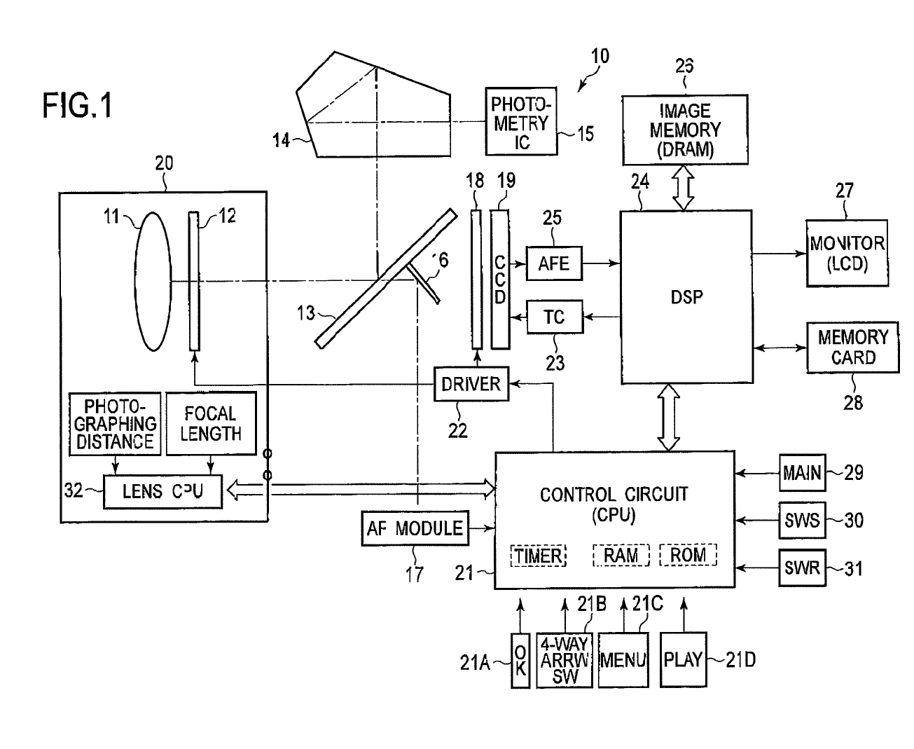

FIG. 1 is a block diagram showing the general structures of a camera that executes composite image creating processing of a first embodiment to which the present invention is applied. In the present embodiment, although a camera is described as an example, the invention can be applied to any type of a device that carries out similar image processing, such as an image management system applied to a computer system and the like.

In the present embodiment, the camera 10 is a digital single reflex camera. An interchangeable lens barrel 20 is provided with a photographic lens 11 and an aperture stop 12. Light enters the camera body through the photographic lens 11 and the aperture stop 12. A reflex mirror 13 at a 45-degree angle with respect to the optical axis of the photographic lens 11 is arranged inside the camera body, and light rays reflected by the reflex mirror 13 are directed toward a focusing screen (not shown) and a pentagonal prism 14. The light rays are further reflected toward an eyepiece and some of the light lays are led to a photometric IC 15 for light metering. A part of the reflex mirror 13 is configured as a half-silvered mirror (a beam splitter) so that light rays that have passed through the beam splitter portion are reflected by a sub mirror 16 attached to the reflex mirror 13 and made incident into an auto focus (AF) module 17.

Behind the reflex mirror 13, a mechanical shutter 18 is disposed. Further, behind the mechanical shutter 18, an imaging sensor 19, such as a CCD, is arranged. The reflex mirror 13 and the sub mirror 16 are driven by a driver 22, which is controlled by a control circuit (GPU) 21.

The CCD 19 is connected to a digital signal processor (DSP) 24 via a timing controller (TC) 23. The DSP 24 drives the timing controller (TC) 23 according to instructions from the control circuit 21 to control the CCD 19. Image signals detected by the CCD 19 are converted into digital signals through an analog front-end (AFE) processor 25 and input to the DSP 24. Furthermore, the digital image signals are temporally stored in image memory (DRAM) 26 while they are subjected to predetermined image processing in the DSP 24.

The image data stored in the imago memory 26 may be displayed on a monitor (LCD) 27 after they are subjected to predetermined image processing or as raw data. Further, the image data may be stored in a recording medium such as a memory card 28 and the like, if required. The DSP 24 can also transmit the image data stored in the memory card 28 to the image memory 26 and subject it to various image processing, including the composite imago-creating processing of the present embodiment. The image data subjected to the image processing may be restored in the memory card 28.

The interchangeable lens barrel 20 is electrically connected to the camera body through a connector. The aperture stop 12 is controlled by instructions from the driver 22 inside the camera body. Further, the control circuit 21 is connected to a lens CPU 32 inside the interchangeable lens barrel 20 through a connector, such that the control circuit 21 receives a focal length and a photographing distance obtained from the lens position via the lens CPU 32 for each captured image.

The control circuit 21 is connected with a main switch (MAIN) 29, a photometry switch (SWS) 30, and a release switch (SWR) 31. When the main switch 29 is turned ON, the electric power from an electric power source 32 is supplied to each of the devices in the interchangeable lens barrel and the camera body. Furthermore, the release button (not shown) is connected to the photometry switch (SWS) 30 and the release switch (SWR) 31, wherein when the release button is depressed halfway, the photometry switch (SWS) 30 is turned ON and the control circuit 21 carries out a photometric process according to signals from the photometric IC 15. Thereafter, the aperture stop 12 is actuated and an autofocus process is also carried out according to signals from the AF module 17.

Moreover, when the release button (not shown) is fully depressed, the driver 22 is activated and rapidly rotates the reflex mirror 13 upward, and the mechanical shutter 18 is driven. Synchronously, the CCD 19 is driven to capture an object image. Incidentally, the image data of the captured image is temporarily stored in the image memory 26, and photographing conditions, such as ISO, an exposure time, an f-number, a photographing mode, and so on, are combined with the image data as a piece of tag information to generate an image file that will be stored in the memory card 28.

Further, an OK button 21A, 4-way arrow buttons 218, a menu button 21C, a play button 21D and so on, are connected to the control circuit 21. The camera's operating modes and the functions in each mode are selected by a user operating these operational switches.

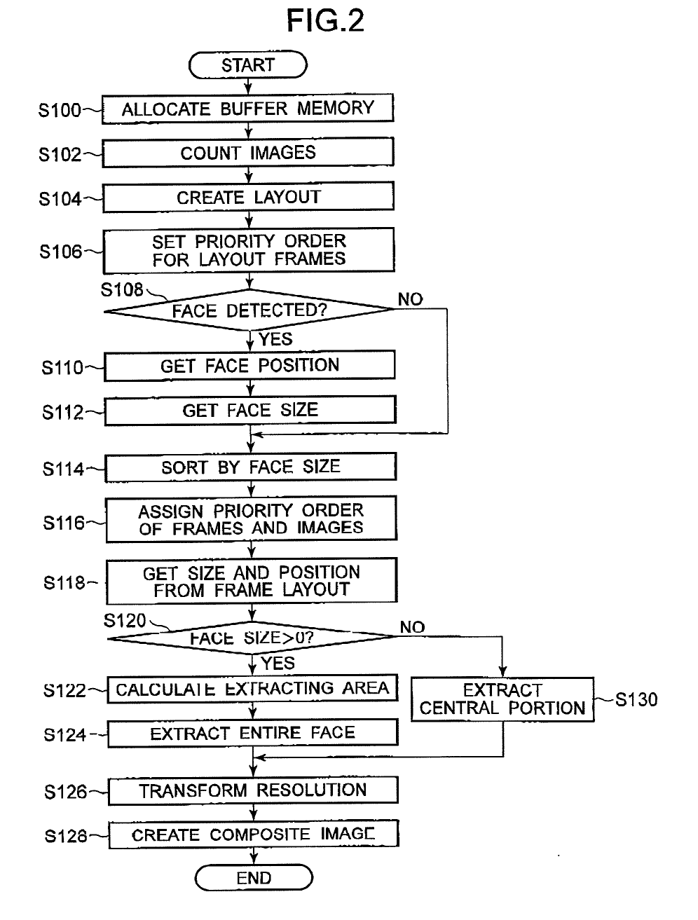

With reference to FIGS. 1-4, the composite image creating process of the present embodiment will be explained. FIG. 2 is a flowchart of a composite image creating process of a first embodiment, which is executed in the DSP 24 inside the camera body in the present embodiment.

The process in FIG. 2 commences when a user selects a mode for the composite image creating process from a menu and selects a folder in the memory card 28 where images are stored by operating the operational switches 21A-21D.

In Step S100, buffer memory for storing image data is allocated in the image memory 26, for example. In Step S102, the images (image data files) existing in the selected folder are counted. In Step S104, layout information that is used in the composition of the images retrieved from the memory card 28 into a single image is created. Further, in Step S106, the priority of each area in the layout is determined.

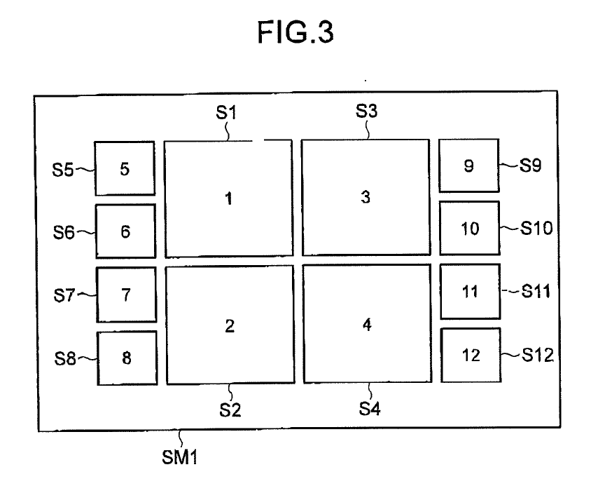

Note that in the first embodiment twelve images in the folder are selected and the twelve images are arranged in a single composite image SM1, as shown in FIG. 3, after being subjected to predetermined processes. The layout of the composite image SM1 includes four large-frame images centrally located in a 2×2 arrangement in the vertical and horizontal directions, and four small-frame images aligned vertically on both sides of the four centrally located large-frame images.

The priority of each frame in this layout is ordered from the upper left large frame arranged in the central area to have the primary priority, with the remaining large frames receiving priority, in descending order, in the counter-clockwise direction down to the fourth priority. The fifth to eighth priorities are assigned to the small-frame images arranged on the left side, from the top to the bottom, and the ninth to twelfth priorities are assigned to the small-frame images arranged on the right side, from the top to the bottom. Note that in FIG. 3, the priority order of each frame is indicated as numerals 1-12 in each of the layout frames.

In the first embodiment, the combination of the size of a frame and the position of an image is employed as an index to define the priority of the layout frames. For example, high priority is assigned to larger frames first, then to frames positioned closer to the center, and finally from upper frames to lower frames.

In Steps S108-S112, face detection processing known in the art is executed for all images in the selected folder. When a face is detected in Step S108, the positional information of the face is obtained in Step S110, and in Step S112 the size information of the face is obtained. The information obtained in these processes is assigned to the corresponding image in which the face is detected. For example, the size information is defined as “0” when no face is detected in the image, and a larger numeral is given in proportion to the size of the face (e.g., based on the ratio of the face area to the entire image area).

In Step S114, the priority order of the images in the folder is determined based on the size information of the face, which is assigned to the images. Namely, in the first embodiment, the priority order of the images in the folder, i.e., from first to twelfth, is determined to be higher as the size of the face increases. Further, as for images in which a face is not detected, the priority order is suitably determined by an algorithm. For example, in descending order of importance with respect to the date, the brightness, and the like, every image in which a face is detected is assigned a certain priority. When the number of the images in the folder is less than twelve, the remaining priority order may be repeatedly assigned to a particular image or to the images that have already been ordered, or further, a certain default image may be used as a substitute. Furthermore, in a situation when a plurality of images is assigned with the same face size, the priority order is further determined under a certain criterion, such as the order of the date, the name, or the like.

In Step S116, the images S1-S12 for which the priority order has been determined are assigned to the twelve layout frames in accordance with the priority order determined for the layout frames. Namely, the images S1-S12 are assigned to the layout frames so that the priority order of the images and layout frames coincide. In step S118, the size of the images S1-S12 and the positional coordinates of the images S1-S12 in the composite image SM1 are calculated in reference to the frame layout.

In Steps S120-S124, the trimming of images S1-S12 is carried out. In the first embodiment, in the case when a face is detected, the image is trimmed in a manner that extracts the face. When no face is detected, however, the image is trimmed by extracting a central part of the image. Namely, in Step S120, it is determined whether or not the size of the face in each of the images S1-S12 is greater than zero. When the size of the face is greater than zero, The process proceeds to Step S122 and the coordinates of the central position of the face are calculated from the positional information of the face. Further, in Step S124, an area around the center of the face, including the entire face, is extracted.

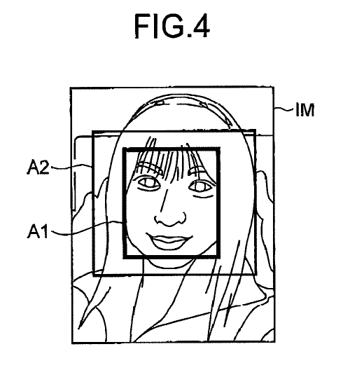

An example of how trimming works when the size of the face is greater than zero is illustrated in FIG. 4. In general, the face detection procedure extracts an area A1 of an image IM of FIG. 4, based on the smallest rectangular area that includes the eyebrows or eyes and the mouth. In contrast, in the present embodiment an area A2 of which the width and height of the area A1 are multiplied by predetermined values is extracted in order to extract the entire face in good balance. In this extraction, the center of the area A2 may be selected as identical to the center of the area A1. Furthermore, the dimension of the area A2 is determined so that the aspect ratio of the area A2 coincides with the aspect ratio of the assigned frame.

On the other hand, when it is determined in Step S120 that the size of the face is equal to 0, a central part of the image is extracted in a predetermined ratio. Note that, as well as the face extraction, the extraction of the central part of the image is also carried out with an aspect ratio that is identical to the assigned frame.

In Step S126, the resolutions of the extracted images S1-S12 are transformed according to the size of the layout frames. In Step S128, the image data of the extracted images S1-S12, which are subjected to the resolution transformation, are allocated in the buffer memory within an area reserved for the composite image SM1 and in the areas corresponding to each of the layout frames. Thereby, the composite image SM1 is created and the composite image creating process is completed. Note that the composite image SM1 created in the buffer memory can be stored in the memory card 28 after the completion of this process, if required.

As described above and according to the composite image creating process of the first embodiment, images that may be highly regarded with much interest from a user, such as an image where a large part of the image is occupied by a human face, can be selected from a plurality of images. Likewise, images that do not include a human face can be excluded from the composite image-creating process. Further, a single composite image is created from images in which a large part are occupied by a human face and are arranged in a layout that makes these images stand out from the other images according to their priority order. Furthermore, in the first embodiment, similar to the method in which a face is extracted from an image to be the core of the extracted image, another subject of a user's interest may also be extracted and highlighted in the composite image layout.

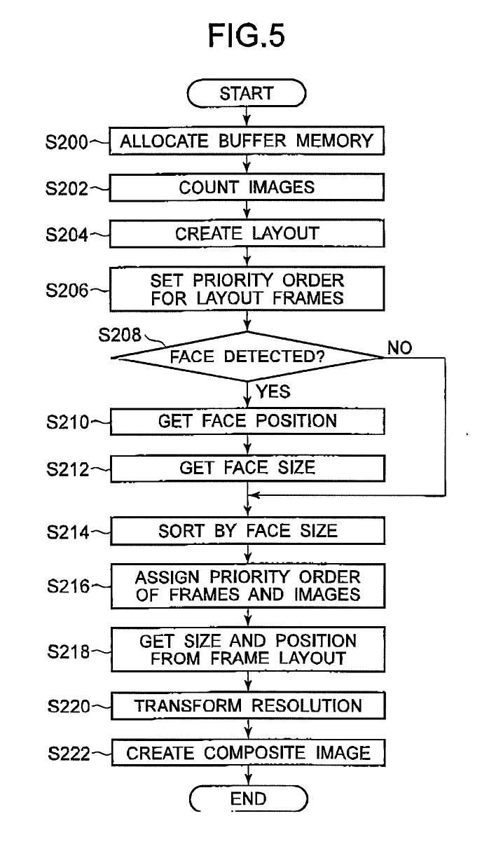

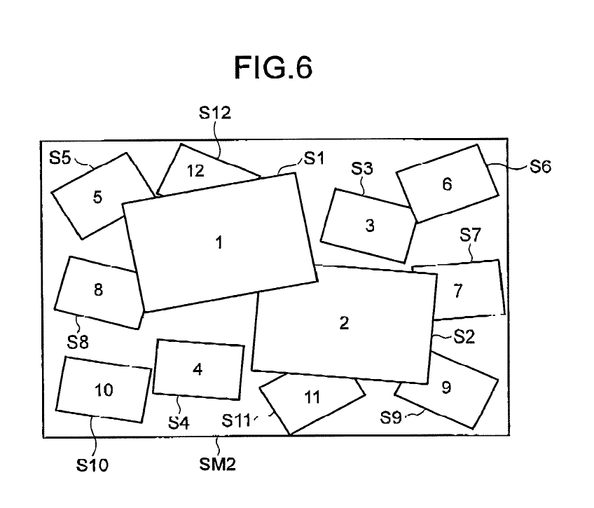

Referring to FIG. 5 and FIG. 6, a composite image creating process of a second embodiment will be explained. In the first embodiment, the layout frames that are prepared for a composite image are regularly arranged and their sizes are given by predetermined dimensions. However, in the second embodiment, the positions and orientations of the frames are irregularly defined and their sizes are also irregular. Namely, the layout of the composite image is designed as if photographs are randomly scattered on a sheet. Further, in the second embodiment, the aspect ratio of an extracted image is kept in the same value as that of the original image.

FIG. 5 is a flowchart of the composite to image creating process of the second embodiment. FIG. 6 illustrates an example of a layout for the composite image of the second embodiment.

As in the first embodiment, the process of FIG. 5 commences when a user selects a mode for the composite image creating process from a menu and selects a folder in the memory card 28 where images are stored, by operating the operational switches 21A-21D.

In Step S200, buffer memory for storing image data is allocated in the image memory 26, for example. In Step S202, the images (the image data files) existing in the selected folder are counted. In Step S204, layout information is created that will be used in the composition of the images retrieved from the memory card 28 into a single image. Further, in Step S206, the priority of each area in the layout is determined.

In the second embodiment, twelve images are also selected from the folder. However, as shown in FIG. 6, in the layout of the composite image SM2 the twelve images are scattered as the sizes, positions, and orientations are irregularly selected. As for the layout of the composite image SM2 that includes the twelve images, large-size frames are assigned the higher priority and arranged in the central part of the composite image, while the remaining frames assigned in descending order of priority are arranged from the upper portion to the lower portion. Note that the priority order of each frame is indicated by numerals 1-12 in each of the layout frames. Further, some of the layout frames overlap each other to some extent.

The above-mentioned layout and the priority order of the frames may be previously given. However, it may be configured so that only the layout is given previously and the priority order is to be selected by a user. Further, it may also be configured so that frames are arranged randomly with the order of priority assigned automatically. In Steps S208-S212, the face detection processing known in the art is executed for all images in the selected folder as in the first embodiment. When a face is detected in Step S208, the positional information of the face is obtained in Step S210, and in Step S212 the size information of the face is obtained. The information obtained in these processes is assigned to the corresponding image, in which the face is detected.

In Step S214, the priority order of the images in the folder is determined based on the size information of the face. Namely, as similar to the first embodiment, the priority order of the images in the folder, i.e., from first to twelfth, is determined to be higher as the size of the face increases. Further, as for images in which a face is not detected, the priority order is suitably determined by an algorithm. For example, in descending order of importance with respect to the date, the brightness, and the like, every image in which a face is detected is assigned a certain priority. When the number of the images in the folder is less than twelve, or in a situation when a plurality of images is assigned with the same face size, the same process as in the first embodiment is carried out.

In Step S216, the images S1-S12, of which the priority order has been determined, are assigned to the twelve layout frames in accordance with the priority order determined for the layout frames. Namely, the images S1-S12 are assigned to the layout frames so that the order of priority of the images coincides with the layout of the frames. In Step S218, the size of the images S1-S12, the positional coordinates and the orientations of the images S1-S12 in the composite image SM2 are calculated with reference the frame layout.

In Step S220, the resolutions of the images S1-S12 are transformed according to the size of the layout frames. In Step S222, the image data of the images S1-S12, which are subjected to the resolution transformation, are allocated in the buffer memory to an area reserved for the composite image SM2 and to the areas corresponding to each of the layout frames. Thereby, the composite image SM2 is crated and this composite image creating process is completed. Note that the composite image SM2 created in the buffer memory can be stored in the memory card 28 after the completion of this process, if required.

As described above and according to the second embodiment, the same effect as the first embodiment can be achieved. Further, in the second embodiment, since the layout frames are arranged irregularly, a composite image is obtained that resembles printed photographs scattered about a panel sheet with photographs of greater interest to a user arranged in the center.

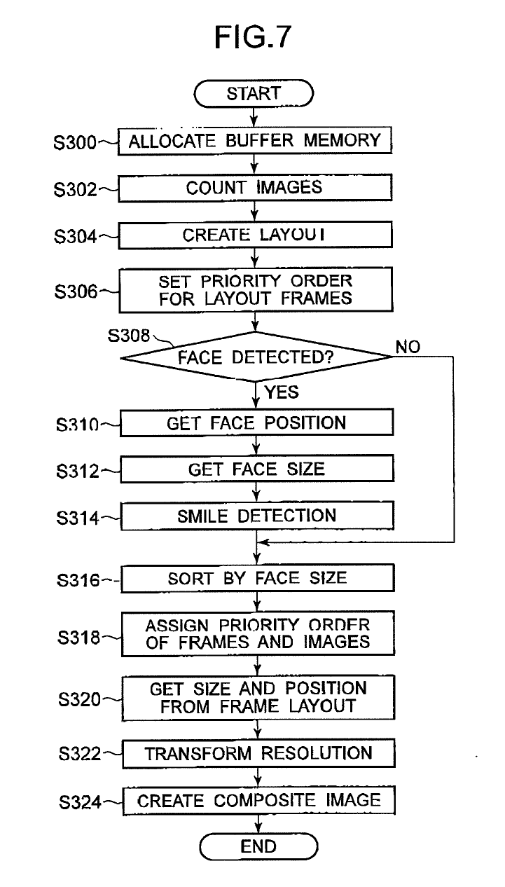

With reference to the flowchart of FIG. 7, a composite image creating process of a third embodiment will be explained. In the third embodiment, the priority order is determined based on the size of a face in the image and the level of its smile.

In Step S300, buffer memory for storing image data is allocated in the image memory 26, for example. In Step S302, the images (the image data files) existing in the selected folder are counted. In Step S304, layout information is created that will be used in the composition of the images retrieved from the memory card 28 into a single image. Further, in Step S306, the priority of each area in the layout is determined. Note that for the layout of the composite image, either of the first embodiment or the second embodiment is employed.

In Steps S308-S312, the face detection processing known in the art is executed for all images in the selected folder as in the first embodiment. When a face is detected in Step S308, the positional information of the face is obtained in Step S310, and the size information of the face is obtained in Step S312. The information obtained in these processes is assigned to the corresponding image in which the face is detected.

Further, in Step S314 of the third embodiment, when a face has been detected in the image a smile level is obtained from the area of the detected face using a smile detection procedure (known in the art). For example, the smile level may be determined by the size of its teeth or a mouth (compared to the face area). The level can also be a determined in a two-step process.

In Step S316, the order of priority of the images in the folder is determined based on the size information of the face. Namely, similar to the first and second embodiments, the order of priority of the images in the folder, i.e., from first to twelfth, is determined to be higher as the size of the face increases. However, in a situation when a plurality of images is assigned with the same face size, the order of priority is further determined according to the descending order of the smile level. Further, when no face is detected in an image and when the number of the images in the folder is less than twelve, the same process as used in the first and second embodiments is carried out to determine the order of priority.

In Step S318, the images S1-S12 of which the order of priority has determined are assigned to the twelve layout frames in accordance with the order of priority determined for the layout frames. Namely, the images S1-S12 are assigned to the layout frames so that the order of priority of the images coincides with the order of priority of the layout frames. In Step S320, the size and the arrangement of the images S1-S12 in the composite image are calculated with reference to the layout of the frames.

In Step S322, the resolutions of the images S1-S12 are transformed according to the size of the layout frames. In Step S324, the image data of the images S1-S12, which are subjected to the resolution transformation, are allocated in the buffer memory to an area that is reserved for the composite image and to the areas corresponding to each of the layout frames. Thereby, the composite image is created and this composite image creating process is completed. Note that the composite image created in the buffer memory can be stored in the memory card 28 after the completion of this process, if required.

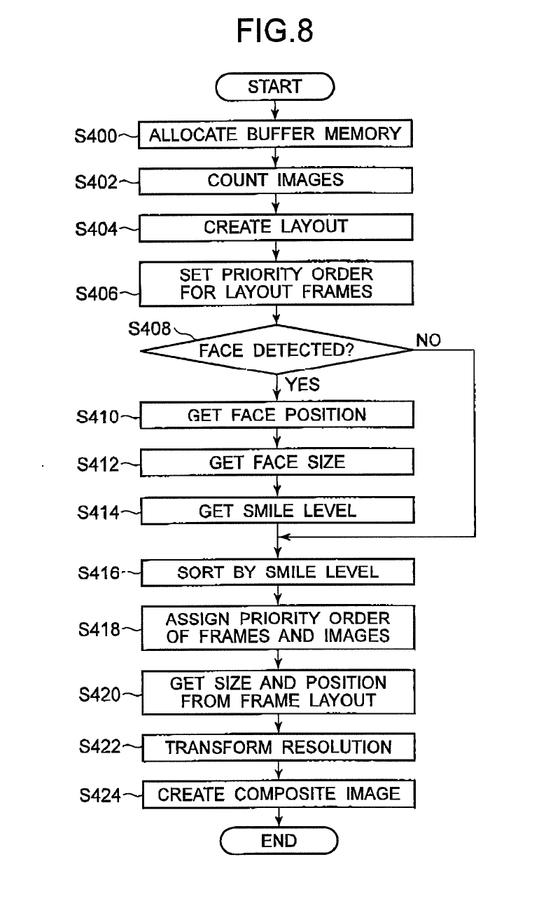

With reference the flowchart of FIG. 8, a composite image creating process of a fourth embodiment will be explained. In the fourth embodiment, the priority order of images is determined based on the size of a face in the image and the level of its smile, in the same manner as the third embodiment. However, what is different from the third embodiment is that the smile level is chosen as a criterion prior to the face size.

Steps S400-S414 of the fourth embodiment are the same as Steps S300-S314 of the third embodiment, so that the order of priority based on the size of a face and the level of the smile are assigned to the images in these steps. In Step S416, dissimilar to the third embodiment, the order of priority of the images is primarily determined according to the smile level, and images assigned with the same smile level are then sorted in descending order based on the size of the ca face, so that twelve images S1-S12 are thus selected. Namely, a smiling image has higher priority than images that are mainly occupied by a face.

Since Steps S410-S424 are the same processes as Steps 318-324 of the third embodiment, the explanation for these steps has been omitted.

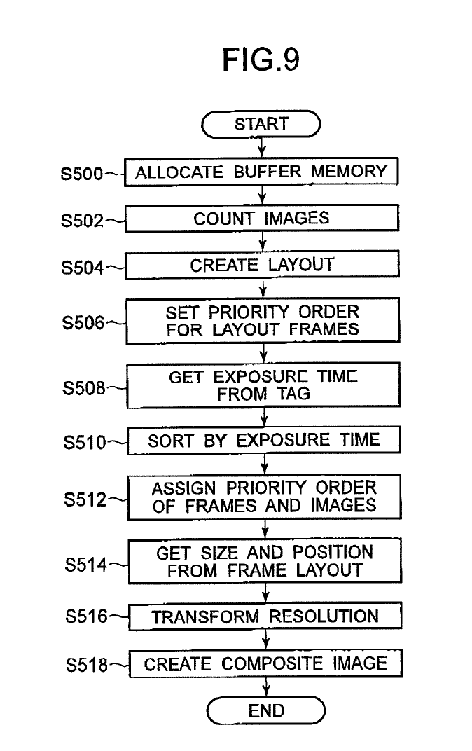

With reference to the flowchart of FIG. 9, a composition image creating process of a fifth embodiment will be explained. In the fifth embodiment, an exposure time is employed as a criterion for setting the order of priority, instead of using either the face size or the smile level. Specifically, in the fifth embodiment the order of priority is sorted in descending order with respect to the length of the exposure time. This may be applied when a user has an interest in a night view. Note that when a user's interest is oriented to an image including a moving object, the order of priority is sorted in ascending order with respect to the length of the exposure time.

In Step S500, buffer memory for storing image data is allocated in the image memory 26, for example. In Step S502, the images (the image data files) existing in the selected folder are counted. In Step S504, layout information is created that will be used in the composition of the images retrieved from the memory card 28 into a single image. Further, in Step S506, the priority of each area in the layout is determined. Note that as for the layout of the composite image, either of the first embodiment or the second embodiment is employed.

In Step S500, the exposure time is obtained from tag information of an image, and in Step S510, the order of priority is assigned to the images in descending order of the exposure times (i.e., a higher priority is assigned to a longer exposure time), from first to twelfth. In Step S512, the images S1-S12 of which the priority order has been determined, from first to twelfth, are assigned to the twelve layout frames in accordance with the priority order determined from first to twelfth for the layout frames.

Namely, the images S1-S12 are assigned to the layout frames so that the order of priority of the images coincides with the layout of the frames. In Step S514, the size and the arrangement of the images S1-S12 in the composite image are calculated with reference to the frame layout.

In Step S516, the resolutions of the images S1-S12 are transformed according to the size of the layout frames. In Step S518, the image data of the images S1-S12, which are subjected to the resolution transformation, are allocated in the buffer memory, to area reserved for the composite image and to the areas corresponding to each of the layout frames. Thereby, the composite image is created and this composite image creating process is completed. Note that the composite image created in the buffer memory can be stored in the memory card 28 after the completion of this process, if required.

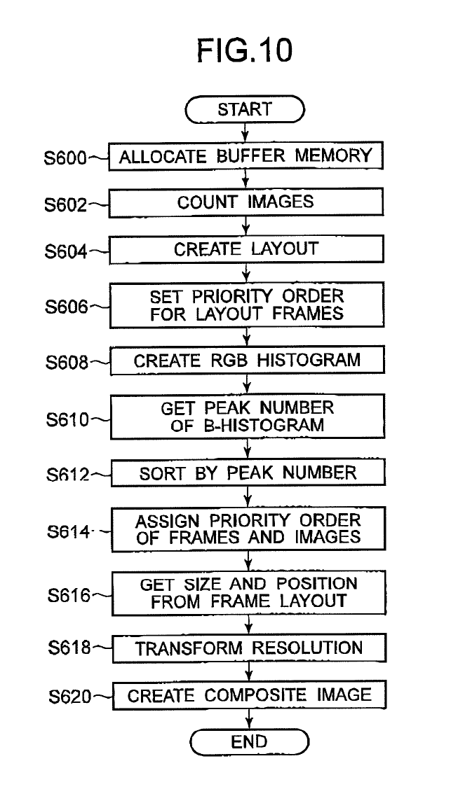

With reference to the flowchart of FIG. 10, a composite image creating process of a sixth embodiment will be explained. In the sixth embodiment, images containing a relatively greater amount of a blue component with respect to the other color components are given higher priority and are arranged accordingly in the composite image clue to the order of priority. This is effective when a user's interest is in images of the sky or sea, of which the level of the blue component surpasses the level of the other color components. Note that when a user is interested in the image of a sunrise or sunset, the images where the level of the red component surpasses the level of the other color components may be given a higher priority. Similarly, the priority of images where the level of a certain color component surpasses the level of other color components can also be set as the higher priority based on the user's discretion.

In Step S600, buffer memory for storing image data is allocated in the image memory 26, for example. In Stop S602, the images (the image data files) existing in the selected folder are counted. In Step S604, layout information is created that will be used in the composition of the images retrieved from the memory card 28 into a single image. Further, in Step S606, the priority of each area in the layout is determined.

In Step S606, histograms of R, C, and B components are created for every image in the selected folder. In Step S610, the number of pixels in the peak of the B component histogram is obtained for each of the images, and in Step S612, the order of priority of the images, from first to twelfth, is determined in descending order according to the number of the pixels in the peak of the B component histogram.

In Step S614, the images S1-S12 of which the priority order has been determined, from first to twelfth, are assigned to the twelve layout frames in accordance with the order of priority determined from first to twelfth for the layout frames. Namely, the images S1-S12 are assigned to the layout frames so that the order of priority of the images coincides with the layout of the frames. In Step S616, the size and the arrangement of the images S1-S12 in the composite image are calculated with reference to the frame layout.

In Step S618, the resolutions of the images S1-S12 are transformed according to the size of the layout frames. In Step S620, the image data of the images S1-S12, which are subjected to the resolution transformation, are allocated in the buffer memory to an area reserved for the composite image and to the areas corresponding to each of the layout frames. Thereby, the composite image is created and this composite Image creating process is completed. Note that the composite image created in the buffer memory can be stored in the memory card 26 after the completion of this process, if required.

As discussed above, according to the present embodiments, images can be selected from a plurality of images according to the user's interest; and further, the selected images can be synthesised in a single composite image with a layout that distinguishes the images that the user is particularly interested in.

Note that a large variety of layouts other than those mentioned above can also be contemplated, such that an exposure mode (a landscape mode or a portrait mode) may be recorded in the tag information of a captured image and landscape images may be arranged around a portrait image positioned at the center. Furthermore, the composite image creating process of the first to sixth embodiments may all be provided as six selective modes, such that a suitable mode can be selected according to a specific situation.

Note that any of the composite image creating processes in the embodiments may be executed in a computer system, and the composite image creating process may also be provided as a software program stored in a recording medium.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No, 2008-240844 (filed on Sep. 19, 2008) which is expressly incorporated herein, by reference, in its entirety.

1. An image processor, comprising:
an image priority order determining processor that determines priority order among a plurality of images based on predetermined priority information;
an image arranging processor that arranges said plurality of images in a layout that distinguishes images that have higher priority in said priority order; and
a composite image creating processor that synthesizes said plurality of images arranged by said image arranging processor into a composite image and stores said composite image in memory.

2. An image processor according to claim 1, wherein said priority information is determined by at least one of a face size, a smile level, a color, and tag information in each image data file corresponding to each image of said plurality of images.

3. An image processor according to claim 2, wherein said priority information is determined by a combination of said face size and said smile level.

4. An image processor according to claim 2, wherein a layout frame for an image of higher priority is set relatively larger than an image of lower priority.

5. An image processor according to claim 2, wherein an image of higher priority is arranged relatively closer to the center of said composite image compared to an image of lower priority.

6. An image processor according to claim 2, wherein an image of higher priority is arranged in an upper position compared to an image of lower priority.

7. An image processor according to claim 1, wherein an image is extracted with a face in the center when said image is arranged in said composite image.

8. A camera comprising:
an image priority order determining processor that determines priority order among a plurality of images based on predetermined priority information;
an image arranging processor that arranges said plurality of images with a layout that distinguishes images having higher priority in said priority order; and
a composite image-creating processor that synthesizes said plurality of images arranged by said image-arranging processor into a composite image and stores said composite image in memory.

9. An image processing method: comprising
determining an image priority order among a plurality of images based on predetermined priority information;
arranging said plurality of images with a layout that distinguishes images having higher priority in said priority order;
synthesizing said plurality of images into a composite image; and
storing said composite image in memory.

10. A computer readable medium comprising computer executable instructions for carrying out a method comprising:
determining an image priority order among a plurality of images base on predetermined priority information;
arranging said plurality of images with a layout that distinguishes images having higher priority in said priority order;
synthesizing said plurality of images into a composite image; and
storing said composite image in memory.
